(19) United States
(12) Patent Application Publication
(10) Pub. No.: US 2011/0002138 A1
(43) Pub. Date: Jan. 6, 2011

(54) SELECTIVELY ILLUMINATED TRIM PANELS

(75) Inventors: Marc A. HAYES, Plymouth, MI (US); Lee CHILDERS, Brighton, MI (US)

Correspondence Address: GROSSMAN, TUCKER, PERREAULT & PFLEGER, PLLC, 55 SOUTH COMMERICAL STREET, MANCHESTER, NH, 03101, US

(73) Assignee: International Automotive Components Group North America, Inc., Deerborn, MI (US)

(21) Appl. No.: 12/497,445

(22) Filed: Jul. 2, 2009

(51) Int. Cl. G02B 6/00; F21S 4/00

(52) U.S. Cl. 362/551; 362/249.16

(57) ABSTRACT

Decorative or protective appliqués' or trim panels having a wide range of decorative patterns may be formed by injection molding a backing layer behind and a transparent outer layer on the top surface of a thin foil, film, fabric or veneer. Use of multiple layers of decorative film, transparent plastic and colored/opaque plastic is also disclosed to provide distinguishing visual effects. The appliqués and trim panels may be backlighted or edge-lighted selectively by providing a light source behind or optically coupled to a runner molded as part of the transparent outer layer.

### FIELD

The present disclosure relates to trim panels and appliqués used in the transportation industry and, more particularly, to the selective illumination of all or a portion of the front surface of such trim panel or appliqué by backlighting or edge-lighting.

### BACKGROUND

Transportation vehicles, particularly automobiles, may be marketed and sold on the basis of differentiation over other competitive models. Differentiation may be by style or color, and is often accomplished by using trim panels or appliqués on the interior or exterior of the vehicle which denote different levels of luxury, price or value. These appliqués or panels may also form protective coverings for areas that protrude from adjacent surfaces. These panels are generally color-coordinated with the adjacent surfaces of the vehicle but may also be bright, reflective, wood-grained, marbleized or metallized in appearance.

Originally, “real” wood appliqués and finished metal panels were used, however, their popularity suffered due to their high cost and limited durability. Subsequently, wood veneers and films with vacuum-deposited metal layers found favor, however, these solutions did not produce the look of luxury or the extended durability required in today's market.

Various proposals have been suggested and practiced for the manufacture of plastic composites for use as automotive interior trim and exterior trim panels or appliqués.

Attention is directed particularly to U.S. application Ser. No. 11/428,107 filed Jun. 30, 2006, which is a continuation of International Application No. PCT/US2005/000170 filed Jan. 3, 2005 and published Aug. 4, 2005 as International Publication No. WO 2005/070647, designating the United States, and to U.S. application Ser. No. 11/532,825 filed Sep. 18, 2006, which is a continuation-in-part of U.S. application Ser. No. 11/428,107, which are commonly assigned to the assignee of the present disclosure, and included herein by reference in their entirety. These applications disclose methods of providing trim panels or appliqués having a wide variety of decorative patterns covered by an outer layer of injection molded, preferably transparent, plastic which provides an exceptional depth of image and luxurious appearance.

These applications further relate to a production method for providing a trim panel or appliqué wherein a decorative layer is positioned between two mold halves and a plastic material is injection molded against one surface of the decorative layer to form a decorative composite Subsequently, the decorative composite is transferred to a second tool where a, preferably transparent, plastic material is injection molded against the front side of the decorative layer. The plastic materials may be of the same or different composition, but preferably one of the materials is a relatively transparent plastic which when provided at an appropriate thickness, yields an appearance of the decorative layer lying under the top surface of the transparent layer, thus having an exceptional depth of image. The decorative layer may comprise a wide variety of thin materials to distinguish its appearance, including, but not limited to; fabric, wood, foil, metal, paper and plastic.

Attention is further directed to U.S. application Ser. No. 12/352,487 filed Jan. 12, 2009, which is a continuation-in-part of U.S. application Ser. No. 11/532,825, which are commonly assigned to the assignee of the present disclosure, and included herein by reference in their entirety. This application discloses a production method for providing a trim panel or appliqué wherein multiple decorative layers may be backed by or separated by layers of transparent and/or colored/opaque plastic by sequentially injecting multiple shots of plastic using multiple tools to provide a trim product or appliqué wherein the decorative layer(s) appear to be floating in the laminated construction.

There are a myriad of locations within a motor vehicle or other transportation means where lighting is desired to provide ambient lighting for aesthetics and effect, orientation lighting for safety and convenience and functional lighting for reading, etc. The integration of electronics into lighting devices in the automobile and, more particularly, lighting has become a selling feature and further enhances the ambiance of the interior environment associated with traveling.

It is contemplated that lighting may be integrated into trim panels and appliqués through backlighting or edge-lighting of the panels to provide even further differentiation and value.

### SUMMARY

In a first aspect the present disclosure relates to an appliqué or trim panel comprising a decorative layer having a top surface and a back surface and including one or more areas capable of transmitting light, a plastic backing layer formed on the back surface of the decorative layer, the backing layer having a back surface and including areas capable of transmitting light, an outer layer formed on the top surface of the decorative layer, wherein the outer layer comprises a transparent plastic, and at least one light source located behind the plastic backing layer which is capable of projecting light through the areas capable of transmitting light in the plastic backing layer, through the areas capable of transmitting light in the decorative layer and through the transparent plastic outer layer to illuminate at least a portion of the appliqué or trim panel.

In another aspect the present disclosure relates to an appliqué or trim panel having edges, comprising a plastic backing layer, an outer layer formed on the backing layer, wherein the outer layer comprises a transparent plastic. The outer layer includes a runner integrally formed along one or more of the edges of the appliqué or trim panel and the runner is configured as a light pipe. The light pipe is then optically coupled with at least one light source to illuminate at least a portion of the appliqué or trim panel.

In still another aspect the present disclosure relates to a method of lighting an appliqué or trim panel by providing a decorative layer having a top surface and a back surface and including one or more areas capable of transmitting light and injection molding an outer layer onto the top surface, wherein the outer layer comprises a transparent plastic. This may be followed by injection molding a plastic backing layer on the back surface of the decorative layer to form the appliqué or trim panel, the backing layer having a back surface and including areas capable of transmitting light, wherein the appliqué or trim panel has a thickness of less than or equal to about 5 mm. This may be followed by providing at least one light source located behind the plastic backing layer which is capable of projecting light through the plastic backing layer, through the areas capable of transmitting light of the decorative layer and the transparent plastic outer layer to illuminate at least a portion of the appliqué or trim panel.

In still another aspect, the present disclosure relates to a method of lighting an appliqué or trim panel having edges, comprising injection molding an outer layer having a back surface and integrally forming a runner along one or more edges, wherein the outer layer comprises a transparent plastic. This may then be followed by injection molding a plastic backing layer on the back surface of the outer layer to form an appliqué or trim panel, wherein the appliqué or trim panel has a thickness of less than or equal to about 5 mm. One may then provide a light source and optically couple the light source to the runner such that the runner acts as a light pipe to illuminate at least a portion of the appliqué or trim panel.

Still other objects and advantages of the present invention will become readily apparent to those skilled in the art from the following detailed description, wherein it is shown and described preferred embodiments of the invention. As will be realized the invention is capable of other and different embodiments, and its several details are capable of modification in various respects, without departing from the invention. Accordingly, the description is to be regarded as illustrative in nature and not as restrictive.

### BRIEF DESCRIPTION OF THE DRAWINGS

The features, operation and advantages of the invention may be better understood from the following detailed description of the preferred embodiments taken in conjunction with the attached drawings, in which

FIG. 1 is a schematic view of a portion of the interior of a motor vehicle illustrating some of the many potential applications for lighted trim panels and appliqués.

FIG. 2A is a plan view of an exemplary appliqué with a lighted periphery, according to the present disclosure.

FIG. 2B is a plan view of an exemplary appliqué with a lighted logo, according to the present disclosure.

FIG. 3 is an enlarged cross-sectional view of a portion of an exemplary appliqué or trim panel, according to the present disclosure.

FIGS. 4-8 are enlarged cross-sectional views of portions of exemplary appliqués or trim panels utilizing multiple decorative layers and transparent and transparent/opaque injection molded layers.

FIG. 9 is a cross-section of a perspective view of an appliqué or trim panel according to another embodiment of the present disclosure, illustrating an integral light pipe.

FIG. 9A is a partial cross-sectional view of the appliqué of FIG. 9 showing a trim panel to cover the runner/light pipe.

FIG. 10 is a cross-section of a perspective view of the appliqué or trim panel of FIG. 9, illustrating a different location for the integrated light pipe.

FIG. 11 is a cross-section of a perspective view of an appliqué or trim panel of FIG. 9, illustrating an integral light pipe which may form a portion of the visible surface of the appliqué or trim panel.

FIG. 12 is a backside view of the appliqué or trim panel of FIG. 10 illustrating the integration of a light source.

FIG. 13 is a cross-sectional view through the center of the appliqué of FIG. 2B illustrating an integration of a light source that may backlight the center of an appliqué.

FIG. 14 is a cross-sectional view through the appliqué of FIG. 2A illustrating an integration of a light source that may backlight the periphery of an appliqué.

FIG. 15 is another cross-sectional view through the appliqué of FIG. 2A illustrating an integration of another light source that may backlight the periphery of an appliqué.

### DETAILED DESCRIPTION

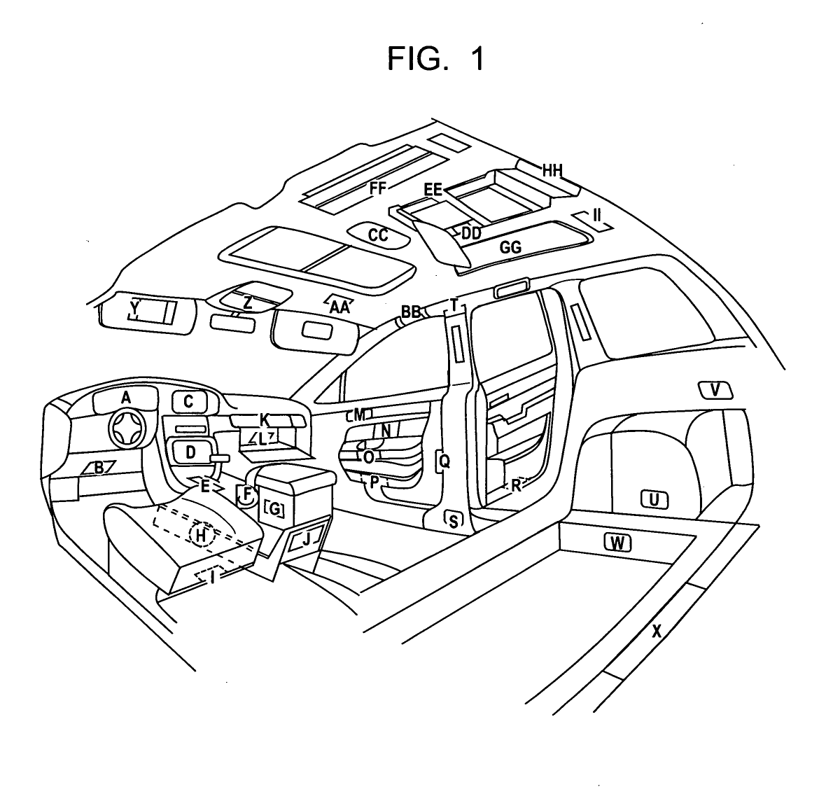

FIG. 1 is a schematic view of the interior of a motor vehicle illustrating some of the many potential applications for lighted appliqués and trim panels. Each of the letter designations (A-II) indicates areas of the interior where lighting devices may be integrated into a trim component to increase the value and versatility of the vehicle. That lighting may further include such features as icons, logos, sensors and switches.

Reference letter A is an example of instrument cluster backlighting. B is an example of footwell lighting for the driver. C is an example of how lighting/controls/touch sensors may be integrated into the infotainment center of a vehicle. D is an example similar to C in the center console area of the vehicle. E illustrates where lighting may be integrated into the PRNDL—shifter area of a console. F illustrates where lighting may be integrated into a cupholder area of a center console. G illustrates where lighting may be integrated into the storage compartment of a center console. H, I and J illustrate additional lighting for foot wells adjacent the center console and for rear passengers under the front seat and rear of the center console, respectively. K represents lighting integrated into a decorative appliqué on the instrument panel. L illustrates where lighting may be integrated into the glove box.

Turning to door trim, M illustrates how lighting may be used to highlight the interior door handle. N represents a trim insert for the door panel, often covered with textile or a perforated cover material, which may be backlit to provide a level of ambient light to the interior. O represents lighting to a pull cup or grip pull handle area and P represents lighting in a storage pocket. Q represents light at a door edge to indicate to oncoming traffic that the door is open. R represents lighting for puddles and outside hazards when the door is open.

Turning to sidewall and storage areas in the vehicle, S represents lighting integrated into the pillar trim for lighting the foot well area of the second row of seating. T is a similar treatment applied to the top of the pillar post to provide light for assistance in entry/exit. U, V and W are examples of where lighting may be applied in the cargo storage area for functional lighting and to illuminate the viewing in dark or shadowed areas. X is a sill plate appliqué that may be applied to the sill of any opening to assist in loading/unloading under low lighting conditions and may serve as a decorative backlighting feature (logo, design, etc).

The overhead system of the vehicle represents numerous opportunities for lighting behind molded grilles, etc. Y is a vanity mirror applied to a visor with lighting and sensing capabilities. Z is a console with map reading lighting. AA is a variant for lighting the vanity minor in the visor and may provide general ambient overhead lighting for the passenger. BB is lighting applied to the headliner to accentuate the grab handle. CC is an example of dome lighting with integral electronics for assisting in entry and general lighting in the vehicle. DD and EE are similar lighting integrated into the overhead console area. FF represents an overhead decorative appliqué with lighting capability. GG represents an overhead lighting panel having a textile outer layer which the lighting may be seen through. HH is a brake light formed according to the present disclosure. II is an overhead panel integrated into the roof portion of the rear storage area.

Appliqués and trim panels may be molded and equipped with lighting capability to project light through, around and along such panels to meet the requirements of many of the above listed applications, according to the present disclosure.

By “appliqué” it is understood to mean a molded panel having a plurality of layers, which may be used as a decorative panel to accentuate or highlight an area of a vehicle and enhance or differentiate the appearance of that area.

By “trim panel” it is understood to mean a molded panel having a plurality of layers, which may have sensing, switching and control functions integrated into the panel and accessible through the top layer.

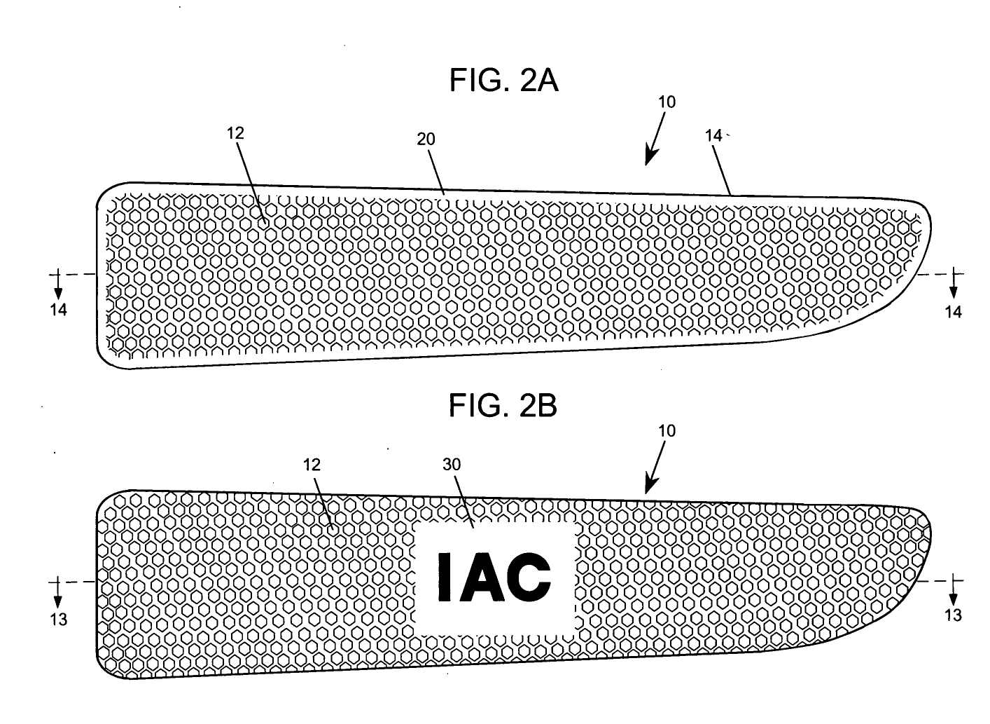

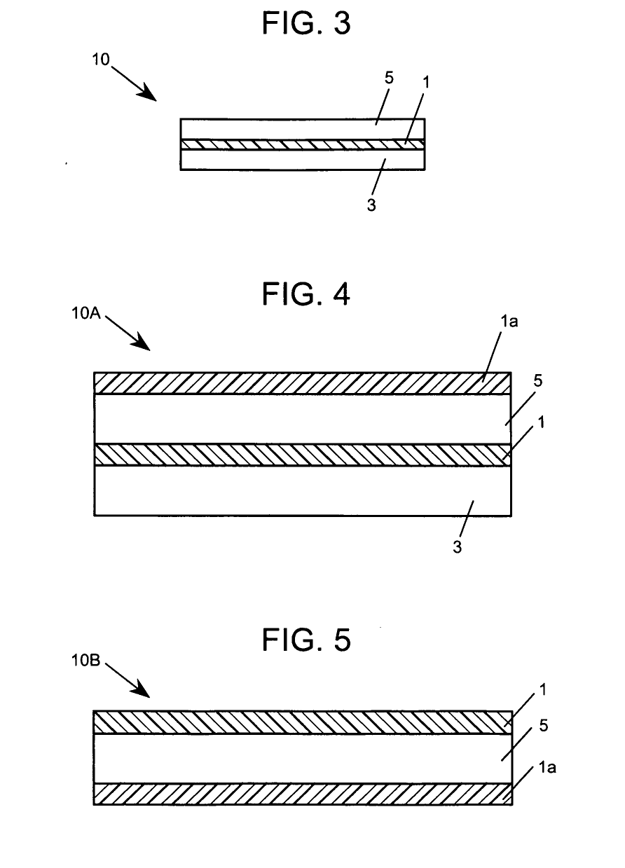

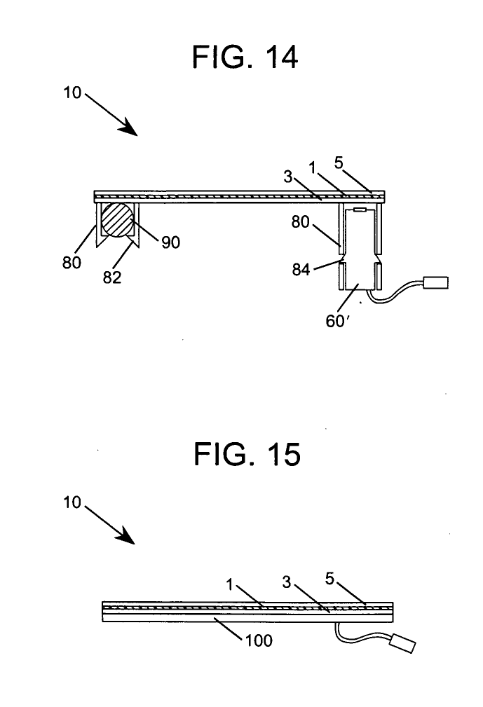

FIG. 2A is a plan view of an exemplary appliqué 10 with a lighted periphery 20, comprising a transparent outer layer 5 overlying a decorative layer 1 which is backed by another transparent plastic layer 3 (see FIG. 3 for a cross-sectional view). The decorative layer 1 is a film or foil having a pattern of non-transparent facets 12 on the outer sides of which layers 3, 5 have been injection molded to form a laminate. The outer periphery 14 of the decorative layer 1 is transparent to allow a light source (not shown) to project light through portions of the laminate and provide halo lighting. This type of appliqué is shown, for instance, in FIG. 1 as reference numerals E, K, M, N, R and X. FIG. 14 illustrates two examples of how the periphery of the appliqué 10 may be backlighted.

FIG. 2B is a plan view of an exemplary appliqué 10 with a lighted logo 30, comprising a transparent outer layer 5 overlying a decorative layer 1 which may be backed by another transparent plastic layer 3 (see FIG. 3 for a cross-sectional view). The decorative layer 1 may be a film or foil having a honeycombed hexagonal or conical pattern of projections 12 and which has been injection molded between layers 3, 5 to form a laminate. The logo area 30 may comprise a section which is transparent or light in color in the decorative layer to highlight the logo from the remainder of the colored opaque appliqué. FIG. 13 illustrates one means for lighting the logo selectively from the backside.

An exemplary construction of the appliqué or trim panel of the present disclosure is shown in simplified cross-sectional view in FIG. 3. The layers as shown are exaggerated in thickness for clarity of the discussion. The relative dimensions of the layers may not be as depicted.

Here, an appliqué 10 comprises a decorative layer 1 having a front side and a back side, which may include, but is not limited to, a foil, film, fabric, veneer, wood, paper, a coating or thin laminate which is covered with a layer 3 of a first plastic on its back side and has a top layer 5 overlying its front side. The top layer 5 is preferably injection molded of a transparent plastic at a thickness to provide the desired depth of image and to protect the thin decorative layer 1. The backing layer 3 is also injection molded and may be of any plastic material and may be transparent or tinted, pigmented or otherwise decorated to enhance the appearance of the decorative layer 1, if so desired. Likewise, the top layer 5 may be tinted, pigmented or otherwise decorated to yield a specific appearance as desired. As noted above, typical decorative materials may include, but, are not limited to, cloth or fabrics, metallized or painted films and foils, metal, wood grain veneers, paper, laminates formed by hydrographic or metal deposition processes, etc. The appliqué or trim panel may be formed according to the teachings of U.S. application Ser. No. 11/428,107 filed Jun. 30, 2006, which is a continuation of International Application No. PCT/US2005/000170 filed Jan. 3, 2005 and published Aug. 4, 2005 as International Publication No. WO 2005/070647, designating the United States, commonly assigned to the assignee of the present disclosure, and included herein by reference in their entirety

Particularly in the case of decorative layers which are somewhat porous, such as cloth, fabric, wood or wood based laminates, paper, etc., it may be desirable to modify the visual appearance of the exposed surface of the decorative material after the backing layer has been injected. This may be the case when the heat and pressure of the first injection of polymer as a backing layer may change the visual characteristics of the exposed surface of the decorative layer. This then may allow a change in color, gloss, texture, pattern, etc., to be imparted to the exposed surface of the decorative layer 1 and any exposed backing layer 3. The procedure may also be used to provide a repair to the exposed surface of the decorative layer 1 for any defects that may have occurred during the injection of the backing layer 3. This may particularly be an issue with wood laminates or veneers which may have an exposed surface which “opens up” or becomes more porous due to the heat and pressure of injection of the backing layer 3. The same modifying/repair procedure may also be applied to the back surface of a decorative layer on which a transparent layer has been molded on the front surface. The appliqué or trim panel may be formed according to the teachings of U.S. application Ser. No. 11/532,825 filed Sep. 18, 2006, which is a continuation-in-part of U.S. application Ser. No. 11/428,107, which are commonly assigned to the assignee of the present disclosure, and included herein by reference in their entirety.

The preferably transparent outer layer 5 may comprise any of the transparent, preferably light stable, plastics available in the art, including but not limited to, polycarbonate, polymethyl-methacrylate, ethylene acrylate (EMA, EEA, EBA), thermoplastic urethane, polyester (PET, PEN), copolyester alloys, cyclic olefin copolymer, poly-4-methyl-1-pentene, polysulphone, allyl diglycol carbonate, allyl ester, styrene-acrylonitrile, methacrylate acrylonitrile-butadiene-styrene, polystyrene, polyamide, polyimide, polysulfone, cellulose acetate (CAB, CAP), glycol modified polyethylene terphthalate, polyvinyl chloride and blends thereof.

By “transparent” it is meant that the layer has the property of transmitting light through the layer with a low degree of diffusion or haze so that bodies lying beyond the layer may be seen relatively clearly. In some cases, 85% of the light may pass through the layer, including all values and increments in the range of 85% to 99.9%, in increments of 0.1%. Diffusion or haze may be understood as the scattering of light from within or from the surface of a layer.

Preferably, the transparent plastic outer layer 5 comprises a copolymer and more particularly a cyclic olefin copolymer, such as TOPAS® 6015S-04 from Ticona, or a co-polyester alloy, such as OPTIMUM® 800 Grade from Engineered Plastics Corporation.

The appliqué 10 may be of any thickness suitable for the application for which the appliqué or trim panel is intended, typically in the range of about 1.0 mm. to about 5.0 mm. with a transparent outer layer 5 typically in the range of about 0.5 mm. to about 2.0 mm. in thickness, depending on the molding properties of the transparent resin used for the outer layer 5.

In another exemplary embodiment, as illustrated in FIGS. 4-5, multiple decorative layers 1, 1a may be included in the construction of the appliqué to provide a distinguishing appearance. The layers as shown are exaggerated in thickness for clarity of the discussion. The relative dimensions of the layers may not be as depicted. The appliqué or trim panel may be formed according to the teachings of U.S. application Ser. No. 12/352,487 filed Jan. 12, 2009, which is a continuation-in-part of U.S. application Ser. No. 11/532,825 filed Sep. 18, 2006, which is a continuation-in-part of U.S. application Ser. No. 11/428,107, which are commonly assigned to the assignee of the present disclosure, and included herein by reference in their entirety.

One or more of the decorative layers 1, 1a may include portions which are transparent allowing a colored or opaque backing layer or light to show through the layered construction. FIG. 4 illustrates a combination of a first decorative layer 1 backed by an injection molded layer of colored or opaque plastic 3 forming a first decorative composite which may then be inserted into a second mold set in which a second decorative layer 1a has been placed. Subsequently, a transparent plastic may be injected between the decorative layers 1, 1a to form a transparent layer 3 and a finished appliqué 10A.

FIG. 5 illustrates another process involving multiple decorative layers wherein a first decorative layer 1 and a second decorative layer 1a may be placed into a mold set, and a transparent resin 5 injected between the decorative layers to form an appliqué 10B. In this example, the second decorative layer 1a may be a bilaminate, such as manufactured by Avery Dennison Corporation comprising two carrier films, one of which has a pattern printed thereupon wherein the graphics lie between the films. The first decorative layer 1 may include at least some transparent portions, through which the graphics or light may be seen. The graphics, due to the relative thickness of the transparent layer 5, may appear to be floating in the transparent layer, providing an exceptional depth of image. As a further feature of the invention, the appliqués formed and configured as described herein having portions which are transparent, may be provided with backlighting to further enhance their appearance. Further, portions of one or both of the decorative layers, 1, 1a may include sections which are opaque and light blocking such that specific areas may show up as black when backlighted to indicate icons, logos, arrows, emblems, etc. It is contemplated that such light blocking areas may reside in a second decorative layer 1a such that they are not visible (behind a pattern in layer 1) and are seen only when the panel is backlighted.

Such icons, logos, arrows and emblems may overlie switches and controls for functions in the vehicle and indicate where pressure may be applied to actuate such switches and controls.

It may therefore be understood that the first and second decorative layers may be different in one or more of the following characteristics: type of decorative pattern, material (polymer type), color, areas of transparency relative to areas of opacity, thickness, hardness, strength (e.g. tensile strength). In addition, each decorative layer may itself be composed of several layers, each with graphics or printing thereon, to provide an overall decorative appearance.

As noted above, typical decorative materials may include, but, are not limited to, cloth or fabrics, metallized or painted films and foils, metal, wood grain veneers, paper, and laminates formed by hydrographic or metal deposition processes.

A coating may be applied to the exposed surface of any of the decorative layers 1, 1a when the mold set is open to further decorate or enhance the appearance of the resultant appliqué 10A, 10B.

In addition, low pressure thermoplastic injection molding may be used to form the appliqué or trim component. Low pressure injection molding generally entails lower clamp pressure (for instance, at or below 2000 psi) than regular injection molding processes due to one or more of the following characteristics: filling the mold while it is partially open (injection-compression), use of cascading sequential gating to distribute the flow, pre-expanding the melt, introducing a gas to fill out a short shot, low speed injection of the polymer, elimination of pack out and hold pressure, use of easy flow, relatively low melt viscosity polymers, and the use of relatively high melt index polymers (e.g. melt index values greater than 5, more preferably melt flow values in the range of 5-50, including all values therein, in 1.0 increments). Polymers which may be used to form the backing layer of the appliqué or trim panel using low pressure injection molding may include, for instance, polyethylene (PE), polypropylene (PP), acrylonitrile-butadiene-styrene (ABS), poly(vinyl chloride) (PVC), polyolefins, polycarbonate (PC) and blends thereof. Such low pressure molding may provide less disruption of the decorative layer, particularly if it is thin, upon injection of the polymer into the mold cavity.

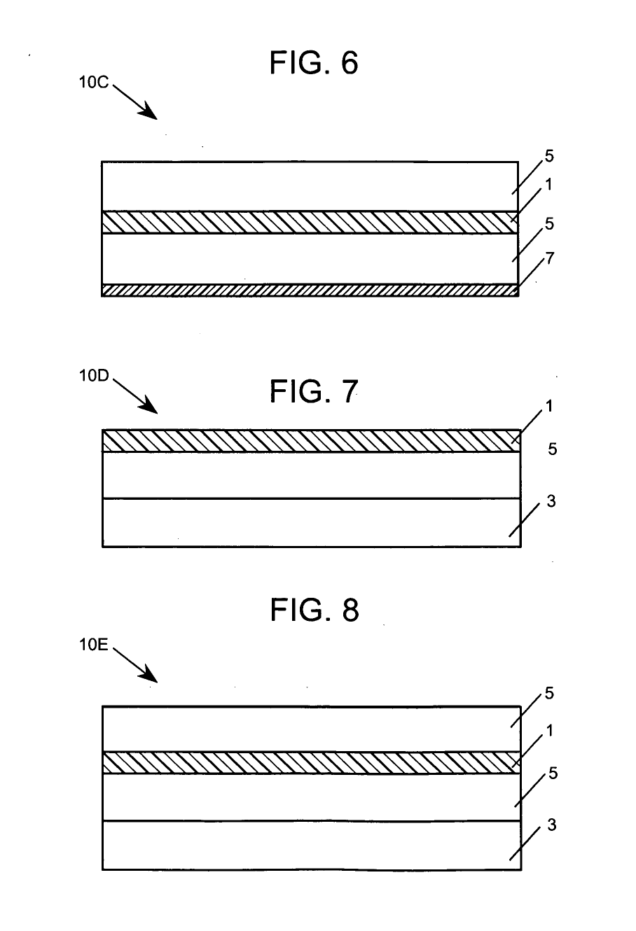

Additional appliqué constructions formed by multi-shot injection molding using the processes disclosed herein are illustrated in FIGS. 6-8. The layers as shown are exaggerated in thickness for clarity of the discussion. The relative dimensions of the layers may not be as depicted.

FIG. 6 is a cross-sectional view of an appliqué 10C wherein a first decorative layer appears to be floating over a second decorative layer, in this case a coating of paint. Here, a first decorative layer 1 is molded with a transparent layer 5 on both the front side and back side, followed by coating one of the exposed surfaces of the transparent layer 3 with a colored paint 7.

FIG. 7 is a cross-sectional view of an appliqué 10D wherein a first decorative layer 1 is backed by an injection molded transparent layer 5 which is in turn backed with an opaque or colored injection molded layer 3. This construction provides a visual effect that whatever is printed on the decorative film may appear to be suspended deep within the transparent layer and on the surface of the opaque or colored layer. For instance, the colored layer may be white, and the graphics of the decorative layer may appear to be floating on the surface of the white substrate. The decorative film layer may have graphics printed on or within the layer as well as transparent areas which may allow one to see the colored layer or light through the film and transparent layer.

FIG. 8 is a cross-sectional view of an appliqué 10E wherein the paint layer 7 in FIG. 6 is replaced with an injection molded colored backing layer 3 of FIG. 7. The backing layer 3 may further include integral or insert-molded fastening means (not shown).

The decorative layer 1 for any of the embodiments shown in the figures may include portions which are transparent allowing light from a light source to show through the layered construction.

By “light source” it is understood to mean an artificial source of light that may be used in conjunction with a plastic panel to transmit light through a portion of that panel.

As used herein, “backlighted” or “backlit” it is understood to mean the providing of a source of light behind one or more layers or surfaces and the projecting of light through at least a portion of such layers so that the foreground appears sharper in contrast to the background. This may allow all or portions of a decorative layer to be enhanced or brightened in appearance.

“Optically coupled” as used herein refer to any connection, coupling, link or the like by which optical signals carried by one optical system element are imparted to the “communicating” or “coupled” element. Such “optically coupled” devices are not necessarily directly connected to one another and may be separated by intermediate optical components or devices. Likewise, the terms “connected” or “coupled” as used herein in regard to physical connections or couplings is a relative term and does not require a direct physical connection.

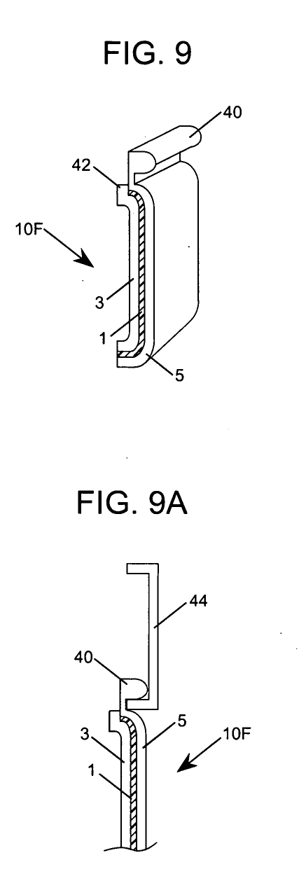

FIG. 9 is a cross-section of a perspective view of an appliqué or trim panel according to another embodiment of the present disclosure, illustrating an integrally formed light pipe. While panels may be backlighted using a variety of light sources, including a light pipe, the present disclosure may allow “edge lighting” by utilizing the runner from the injection molding of the transparent outer layer 5 as a light pipe. When a polymer is injection molded, particularly to form a relatively thin cross-section such as the transparent layer of the present disclosure, for instance less than or equal to 2 mm, a somewhat larger runner may feed a relatively narrow gate to introduce the polymer preferably under laminar flow into the injection cavity.

For appliqués or panels having a relatively high length to width ratio, the runner may extend along one or both sides of and for nearly the entire length of the appliqué. Accordingly, in the context of the present invention, a runner may be understood as an elongated section of plastic material, that serves to introduce plastic into a selected location in a mold for forming a plastic part (via laminar flow) which elongated section may also configured to remain permanently attached to the part and to convey light from a light source to all or a portion of the molded plastic part. In such regard, the runner is not a conventional runner in the sense that a conventional runner is typically designed to be removed and does not take into consideration light transmission requirements.

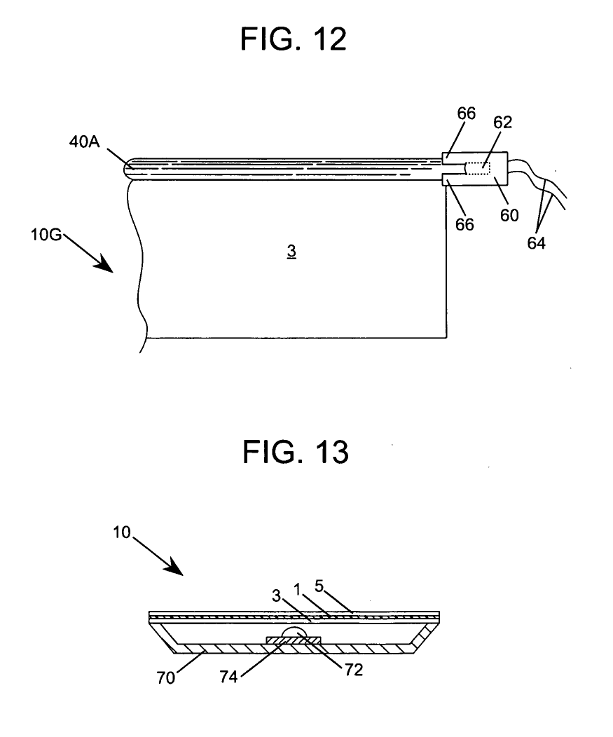

As shown in FIG. 9, an appliqué or trim panel 10F may comprise a decorative layer 1, backed by a backing layer 3 and having a transparent layer 5 molded onto the front side. A runner 40 usually of round or half-round cross-section, about 10-15 mm. in diameter may feed a gate 42 having an opening of about 1 mm. to allow the thickness of the transparent layer 5 to be filled out. Rather than trimming off the runner 40 after molding, since it is molded of the same transparent plastic as the transparent layer 5, it may function as a light pipe by optically coupling a light source to one or both ends or along its length (see FIG. 12). As shown in schematic partial cross-sectional view in FIG. 9A, the runner 40 may be covered by an adjacent trim panel 44 such that the runner or light pipe is not visible to the occupant in the vehicle and may provide a lighted layer (5) in the appliqué 10F. It is contemplated that as shown in FIG. 9, the decorative layer 1 may the removed, yet the runner 40 may still provide (with an appropriate light source) illumination through the runner 40 and into all or a portion of the transparent layer 5.

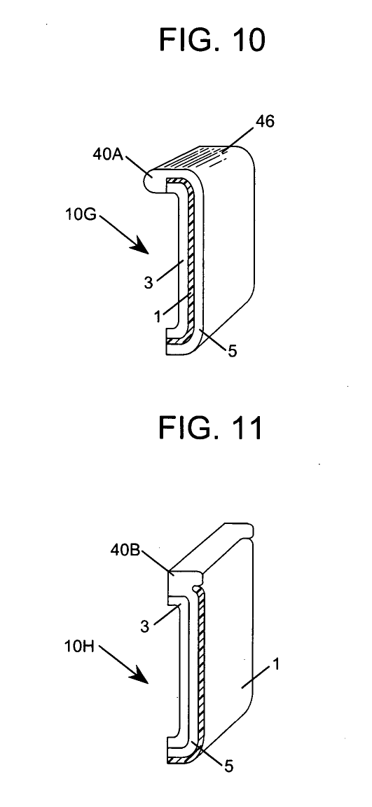

FIG. 10 is a cross-section of a perspective view of the appliqué or trim panel of FIG. 9, illustrating a different location for the integrated light pipe. In this case, the runner 40A is molded behind the appliqué or trim panel 10G by using retractable loose pieces in the mold that would be retracted after molding. Thus, the runner 40A does not become part of the front surface of the appliqué. A roughened surface or molded-in pattern, for instance of saw-toothed or scalloped grooves, 46 may be provided along a portion of the runner 40A to assist in directing the light from exiting the runner by Total Internal Reflection (TIR). Reflective strips may be locally applied or molded-in to further direct the light as desired.

While not shown, it is further contemplated that a separate light pipe or light guide may be optically coupled to the edge of a transparent layer of an appliqué or trim panel and provide a similar lighting effect, rather than having the light pipe integrally molded as the runner for the clear outer layer 5. Such light sources are shown in FIG. 14 and may be positioned along the edge of the panel either by turning the edge of the appliqué towards the light source to allow optical coupling (as in FIG. 10), or in the case of a relatively flat appliqué (FIG. 2A) hiding the light source behind an adjacent panel (as in FIG. 9A).

FIG. 11 is a cross-section of a perspective view of the appliqué or trim panel of FIG. 9, illustrating an integrated light pipe 40B formed from the runner in the molding process where the runner is left exposed as a decorative and functional part of the appliqué 10F. This may provide a “halo-like” effect to a portion or all of the periphery of the appliqué in addition to lighting the transparent layer 5 of the appliqué. In this instance, the decorative layer 1 may overlie the transparent lighted layer 5 to aid in accentuating images, graphics, etc. in the decorative layer.

With any of the integrated runners which may form a light pipe in FIGS. 9-11, it is contemplated that the appliqué or trim panel may not include a decorative layer but instead comprise an injection molded transparent layer over a colored backing layer and that such edge lighting may provide an enhanced appearance of the backing layer.

FIG. 12 is a backside view of the appliqué or trim panel of FIG. 10 illustrating one exemplary embodiment of the integration of a light source. In this view, the backing layer 3 of the appliqué 10G is shown along with the clear runner or integrated light pipe 40A. To supply light to the runner 40A, a connector 60 is provided which may include a light source 62 such as a light emitting diode (LED) or other source of light which may be used to light a portion of the appliqué 10G. The connector 60 may overlap a portion or all of the end of the runner 40A and may include protrusions 66 which may be spaced apart by less than the diameter of the runner 40A such that they may be spread slightly upon engaging the end of the runner and may grasp the runner to provide optical coupling of the light source 62 with the light pipe 40A. Either or both of the protrusions 66 and the end of the runner 40A may further include detents, ridges and tapered portions such that a mechanical coupling of the connector 60 and runner/integrated light pipe 40A may be made. Wires 64 are shown which connect the light source to a power source. LED's may work well in such applications as they are relatively small in size and focused in intensity. The light source 62 may be contained within the connector 60 and include socket and reflector (not shown). An end of the light source will preferably be located closely adjacent to or in contact with the end of the runner/integrated light pipe 40A so that light may be transported along the light pipe and/or across at least a portion of the surface of the appliqué 10G.

FIG. 13 is a cross-sectional view through the center of the appliqué of FIG. 2B illustrating an integration of a light source to selectively light a center area, such as a logo. Here, as shown in FIG. 3, an appliqué 10 may comprise a decorative layer 1, such as cloth, wood, paper, a laminate, film or foil having at least one portion which is transparent to light and may include graphic patterns, logos, text, icons, etc. capable of being lighted from behind. FIG. 2B illustrates a logo which is selectively lighted from behind to distinguish the log from its surroundings. The appliqué 10 further comprises a transparent outer layer 5 and a backing layer 3 which may be at least selectively transparent to allow the light to be transmitted through transparent areas of the decorative layer 1 and the transparent outer layer 5. The backing layer 3 may include areas that are opaque and may act as a blocking layer to prevent light transmission locally. A back panel 70 holds a printed circuit board or wiring panel 74 to which is connected a light source 74. The light source may be of any type, for instance, incandescent, fluorescent, LED, electroluminescent, neon, argon, etc. A plurality of bulbs may be used to provide uniform lighting or to selectively light various areas of the appliqué 10. In addition to individual bulbs, light pipes and light guides may also be used to provide light for various areas of the appliqué. Reflectors, diffusers, diverters and shields may also be configured within the back panel to provide types of special effects. Heat insulating elements as well as convection means for hot air may be useful.

FIG. 14 is a cross-sectional view through the center of the appliqué of FIG. 2A illustrating other exemplary embodiments of attachment of a light source to the appliqué 10. As described in FIG. 3, the basic construction of the appliqué 10 of FIG. 2A includes a decorative layer 1 having some transparent portions, an outer transparent layer 5 and a backing layer 3 which may also have transparent portions. The backing layer 3 may include mounting features 80 attached to the backside of the backing layer 3 which may accept various types of light sources for backlighting the periphery 20 of appliqué 10. FIG. 14 illustrates an acrylic light pipe 90 and an LED light module 60′ either of which may be used to selectively light edge portions of the appliqué 10 by transmitting light through transparent portions of the backing layer 3, decorative layer 1 and transparent outer layer 5. Such light sources may also be positioned to light a center logo as shown in FIG. 2B. The mounting features 80 and/or the light sources 90, 92 may further include detents 82,84, ridges and tapered portions such that a mechanical coupling of the light sources 90, 92 and the mounting features 80 on the backside of the appliqué 10 may be made. Since the backing layer 3 may be injection molded behind the decorative layer 1, it may be preferable that the mounting features 80 be integrally molded with the backing layer.

FIG. 15 is a cross-sectional view through the center of the appliqué of FIG. 2B illustrating another exemplary embodiment of attachment of a light source to the appliqué 10. Here, an electroluminescent light film 100 may be adhesively attached, for instance, with a pressure sensitive adhesive (PSA) to the backside of the backing layer 3 of appliqué 10 and provide full area lighting or selective backlighting to the appliqué.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An appliqué or trim panel comprising;
a decorative layer having a top surface and a back surface and including one or more areas capable of transmitting light;
a plastic backing layer formed on said back surface of said decorative layer, said backing layer having a back surface and including areas capable of transmitting light;
an outer layer formed on said top surface of said decorative layer, wherein said outer layer comprises a transparent plastic; and
at least one light source located behind said plastic backing layer which is capable of projecting light through said areas capable of transmitting light in said plastic backing layer, through said areas capable of transmitting light in said decorative layer and through said transparent plastic outer layer to illuminate at least a portion of said appliqué or trim panel.

2. The appliqué or trim panel of claim 1 wherein said transparent plastic comprises polycarbonate, poly(methyl methacrylate), thermoplastic urethane, polyester, copolyester alloy, cyclic olefin copolymer, poly-4-methyl-1-pentene, polysulphone, allyl diglycol carbonate, allyl ester, styrene-acrylonitrile, polystyrene, polyvinyl chloride and blends, alloys and combinations thereof.

3. The appliqué or trim panel of claim 1 wherein said decorative layer comprises one of a film, a foil, a laminate, a veneer, a fabric, paper or a coating.

4. The appliqué or trim panel of claim 1 wherein one or more of said backing layer and said outer layer include one or more pigments, tints, colored dyes, metallic flakes or light reflective particles therein.

5. The appliqué or trim panel of claim 3 wherein said veneer includes a wood grain pattern.

6. The appliqué or trim panel of claim 1 wherein said at least one light source is attached to said back surface of said backing layer.

7. The appliqué or trim panel of claim 1 wherein said light source is an incandescent bulb, a fluorescent bulb a light emitting diode (LED), a light pipe, an electroluminescent device, a neon or argon bulb or fiber optics.

8. The appliqué or trim panel of claim 1 wherein said light source is optically coupled to said backing layer.

9. The appliqué or trim panel of claim 1 wherein a light blocking layer comprises a portion of said decorative layer or said backing layer.

10. The appliqué or trim panel of claim 1 wherein said backing layer includes mounting features for said at least one light source and said features are integrally formed with said backing layer.

11. An appliqué or trim panel having edges, comprising;
a plastic backing layer;
an outer layer formed on said backing layer, wherein said outer layer comprises a transparent plastic;
wherein said outer layer includes a runner integrally formed along one or more of said edges, said runner configured as a light pipe; and
said light pipe is optically coupled with at least one light source to illuminate at least a portion of said appliqué or trim panel.

12. The appliqué or trim panel of claim 11 wherein said runner is located substantially along said edge and is covered from view by an adjacent opaque trim panel.

13. The appliqué or trim panel of claim 11 wherein said runner is located substantially along said edge and forms a visible lighted edge.

14. The appliqué or trim panel of claim 11 wherein said runner is located substantially behind said backing layer.

15. The appliqué or trim panel of claim 11 wherein said transparent plastic comprises polycarbonate, poly(methyl methacrylate), thermoplastic urethane, polyester, copolyester alloy, cyclic olefin copolymer, poly-4-methyl-1-pentene, polysulphone, allyl diglycol carbonate, allyl ester, styrene-acrylonitrile, polystyrene, polyvinyl chloride and blends, alloys and combinations thereof.

16. The appliqué or trim panel of claim 11 further including a decorative layer formed between the backing layer and said outer layer.

17. The appliqué or trim panel of claim 16 wherein said decorative layer comprises one of a film, a foil, a laminate, a veneer, a fabric, paper or a coating.

18. The appliqué or trim panel of claim 11 wherein one or more of said backing layer and said outer layer include one or more pigments, tints, colored dyes, metallic flakes or light reflective particles therein.

19. The appliqué or trim panel of claim 18 wherein said veneer includes a wood grain pattern.

20. The appliqué or trim panel of claim 11 wherein said at least one light source is attached to one or both ends of said runner or at a point along said runner.

21. The appliqué or trim panel of claim 11 wherein said at least one light source is an incandescent bulb, a fluorescent bulb a light emitting diode (LED), a light pipe, an electroluminescent sheet, a neon or argon bulb or fiber optics.

22. The appliqué or trim panel of claim 11 wherein a plurality of light sources are arranged along said edge.

23. The appliqué or trim panel of claim 16 wherein a second decorative layer may overlie said transparent outer layer.

24. A method of lighting an appliqué or trim panel comprising:
providing a decorative layer having a top surface and a back surface and including one or more areas capable of transmitting light;
injection molding an outer layer onto said top surface of said decorative layer, wherein said outer layer comprises a transparent plastic;
injection molding a plastic backing layer on said back surface of said decorative layer to form said appliqué or trim panel, said backing layer having a back surface and including areas capable of transmitting light, wherein said appliqué or trim panel has a thickness of less than about 5 mm;
providing at least one light source located behind said plastic backing layer which is capable of projecting light through said plastic backing layer, through said areas capable of transmitting light of said decorative layer and said transparent plastic outer layer to illuminate at least a portion of said appliqué or trim panel.

25. The method of claim 24 wherein said at least one light source is one or more of an incandescent bulb, a fluorescent bulb a light emitting diode (LED), a light pipe, an electroluminescent sheet, a neon or argon bulb or fiber optics.

26. The method of claim 24 wherein said decorative layer includes opaque areas capable of blocking light and said opaque areas are only visible to an observer when the appliqué is lighted.

27. The method of claim 24 wherein said at least one light source is attached to said back surface of said backing layer.

28. The method of claim 24 wherein said backing layer includes mounting features for said at least one light source and said features are integrally formed with said backing layer by injection molding.

29. A method of lighting an appliqué or trim panel having edges, comprising:
injection molding an outer layer having a back surface and integrally forming a runner along one or more edges, wherein said outer layer comprises a transparent plastic;
injection molding a plastic backing layer on said back surface of said outer layer to form an appliqué or trim panel, wherein said appliqué or trim panel has a thickness of less than or equal to about 5 mm;
providing a light source;
optically coupling said light source to said runner such that said runner acts as a light pipe to illuminate at least a portion of said appliqué or trim panel.

30. The method of claim 29 wherein said light source is one or more of an incandescent bulb, a fluorescent bulb a light emitting diode (LED), a light pipe, an electroluminescent sheet, a neon or argon bulb or fiber optics.

31. The method of claim 29 further including positioning a decorative layer between said backing layer and said outer layer.

32. The method of claim 31 wherein said decorative layer includes opaque areas capable of blocking light and said opaque areas are only visible to an observer when the appliqué is lighted.
